(19) United States
(12) Patent Application Publication
(10) Pub. No.: US 2019/0075898 A1
(43) Pub. Date: Mar. 14, 2019

(54) PET SUPPLY TRAVEL CARRIER

(71) Applicant: Alan Friedgood, Delray Beach, FL (US)

(72) Inventor: Alan Friedgood, Delray Beach, FL (US)

(21) Appl. No.: 15/992,007

(22) Filed: May 29, 2018

Related U.S. Application Data
(60) Provisional application No. 62/556,174, filed on Sep. 8, 2017.

(51) Int. Cl. A45C 7/00; A01K 5/01; A45C 13/00

(52) U.S. Cl. CPC A45C 7/0095; A45C 13/005; A45C 7/0086; A01K 5/0114

(57) ABSTRACT

A carrier in the form of a backpack, tote, or duffle bag that includes various pockets, sleeves, and a fold down tray is disclosed. The carrier includes a pair of bowls for food and water secured in pockets or pouches, as well as retention means for a water bottle and food container. The carrier also includes a releasable tray hinged to a bottom edge of the carrier, the tray sized to seat an included food bowl and water bowl so that the bowls will not slide around on the ground.

### CROSS-REFERENCES TO RELATED APPLICATIONS

This application claims priority from U.S. Application No. 62/556,174, filed Sep. 8, 2017, the content of which is fully incorporated by reference herein.

### BACKGROUND

The invention relates generally to pet accessories, and more particularly to a pet supply carrier that can be toted or carried easily and comfortably while providing all essential supplies to care for and feed a pet such as a canine.

As pet owners can attest, tending to a dog while away from the home can be a trying endeavor. Whether traveling on vacation or simply out for a day, when including a dog on an outing there can be a variety of items to meet the dog's needs. For example, a dog requires frequent water and food, and may also periodically need medicine, brushing, weather gear, and the like. The pet owner will typically throw some pet products in a plastic bag and leave the house, only to learn later that an important pet care item was left at home. Many times there are no convenient places that such items can quickly and easily be obtained. The prior art lacks a convenient, lightweight carryall specifically designed to meet the needs of a pet owner in which a complete set of pet necessities can be easily transported or carried while traveling with a pet. The present invention addresses this need.

### SUMMARY OF THE INVENTION

The present invention is a carry-all such as, for example, a tote, duffle bag, backpack, or the like that includes various pockets, sleeves, and a fold down tray to care for a pet while traveling. The carry-all includes a pair of bowls for food and water secured in pockets or pouches, as well as retention means for a water bottle and food container. Other compartments are provided for bulkier items such as a blanket and chew toys, and a side mesh pocket allows for easy access to more frequently used items. The carry-all also includes a releasable tray hinged to a bottom edge of the carrier, the tray sized to seat an included food bowl and water bowl so that the bowls will not slide around on the ground. A hook and loop fastener on the tray and bottom of the bowls can be used to secure the bowls to the fold down tray.

These, and other features of the present invention will best be understood with reference to the following drawings and the detailed description of the inventor's best modes of the invention set forth below.

### BRIEF DESCRIPTION OF THE DRAWINGS

FIG. 1 is an elevated, perspective view of a first embodiment of the present invention;

FIG. 2 is an elevated, perspective view of the first embodiment on a piece of luggage;

FIG. 3 is an elevated, perspective view of an alternate embodiment of the present invention; and

FIG. 4 is an elevated, perspective view of a second alternate embodiment of the present invention.

### DETAILED DESCRIPTION OF THE PREFERRED EMBODIMENTS

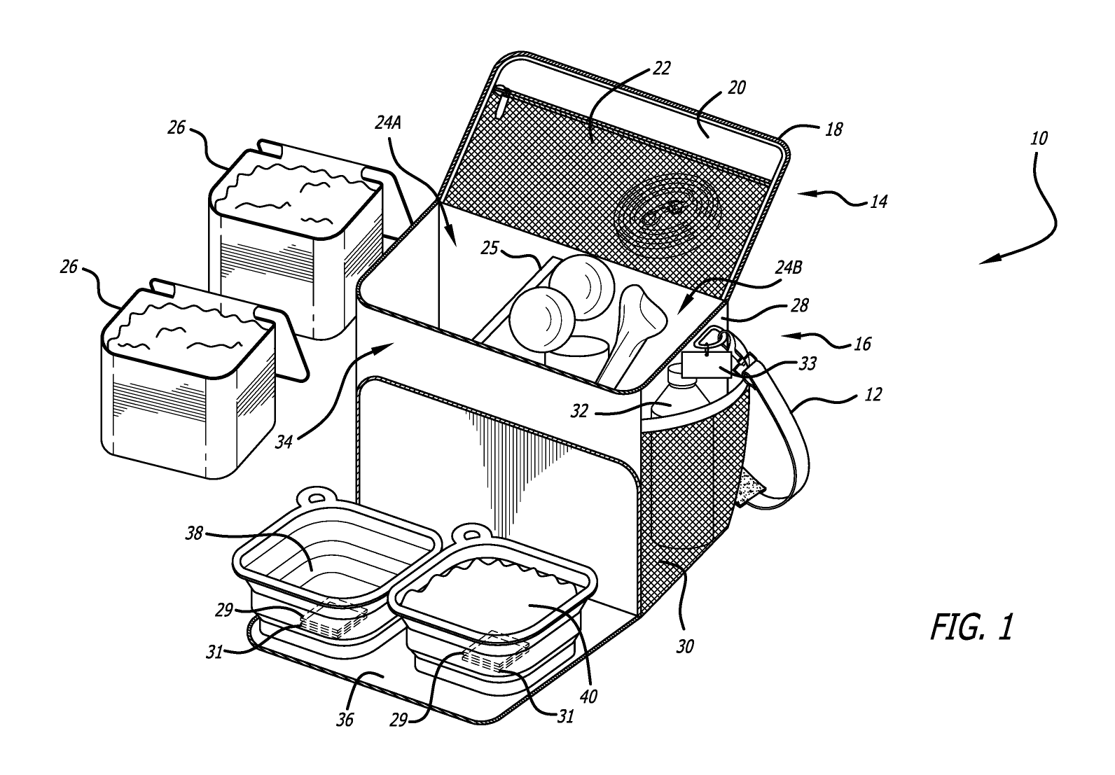

FIG. 1 illustrates a first embodiment of the present invention. A carrier 10 is formed of a flexible-walled, insulated material in the shape of a rectangular tote bag having an adjustable padded shoulder strap 12 swivel-connected at respective sides to the carrier along an upper edge. A luggage ID tag 33 may also be provided along the upper edge. The carrier has a top 14 connected to a body 16 of the carrier by a zipper 18, although other connection methods are possible. The inside surface 20 of the top 14 forms a zippered inside pocket 22 for secure storage. The inside pocket 22 can store a measuring cup for food, and smaller items that can be easily lost such as tubes of medicine, scissors, a leash, etc. The body 16 of the carrier may be divided into two separate compartments 24A, 24B by a central dividing panel 25, where each compartment is sized to store one of two inner-lined food/treat containers 26. If the inner-lined food/treat containers 26 are loaded in the body 16 of the carrier 10, a volume above the containers can be used to hold smaller items such toys, treats, toys, and the like. In a preferred embodiment, the exterior side 28 of the carrier 10 includes a flexible mesh pocket 30 that can be used to hold a bottle of water 32.

The exterior front 34 of the carrier 10 includes a zippered tray 36 that is hinged at a bottom edge and held against the exterior front 34 by a circumferential zipper. When feeding the pet, the zipper can be unzipped to release the tray 36 from its stored position to so that it may lay flat against the ground. The tray 36 is sized to seat a water bowl 38 and a food bowl 40, and the bowls 38, 40 can be stored in the compartment 24B when not in use. To further secure the bowls 38, 40 to the tray 36, a hook and loop fastener 29, 31 can be attached to the bottom of the bowls and the upper surface of the trays to prevent the trays from sliding or spilling as they are want to do when pets are using the bowls. The bowls can also be alternatively stored on a front flap (not shown) to free up space in compartment 24B.

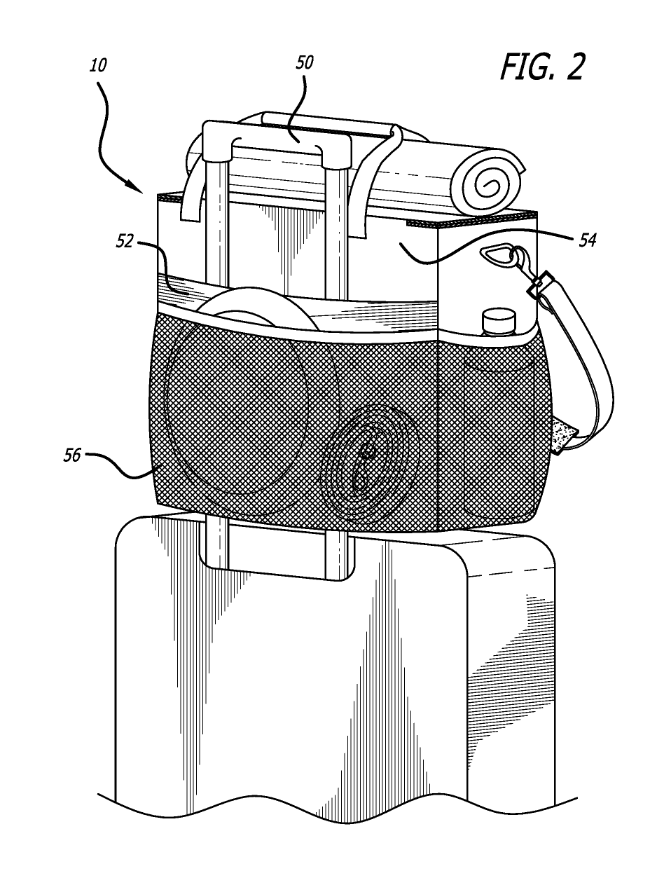

FIG. 2 illustrates the carrier 10 on a piece of luggage. The luggage has an extendable handle 50, which slips through a luggage handle sleeve 52 on an exterior back side 54 of the carrier 10. The sleeve 52 is formed by attaching a flexible material sheet across the back side 54 and then attaching the side edges of the sheet to the back side 54 while leaving unattached the upper and lower edges. Thus, a user can set the carrier 10 on a piece of luggage and allow the luggage's handle to secure the carrier via the sleeve 52 without needing to hold the carrier. A rear mesh pocket 56 can be attached over the sleeve 54 for storing gear or equipment for the pet, such as a leash or weather clothing.

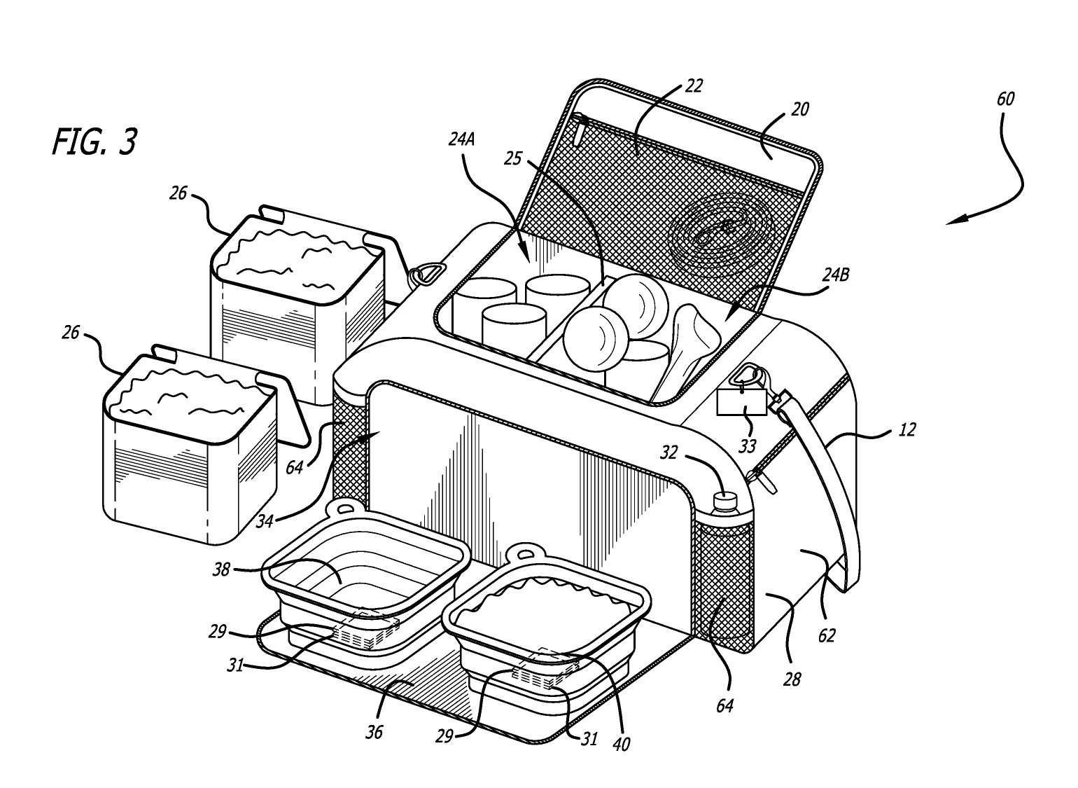

FIG. 3 is an alternate embodiment where the tote of FIG. 1 has been replaced with a duffle bag 60. Duffle bag 60 includes all of the features of the carrier 10, but additionally includes third and fourth compartments 62 on the sides of the duffle bag 60, and additional pockets 64 on each side of the front surface.

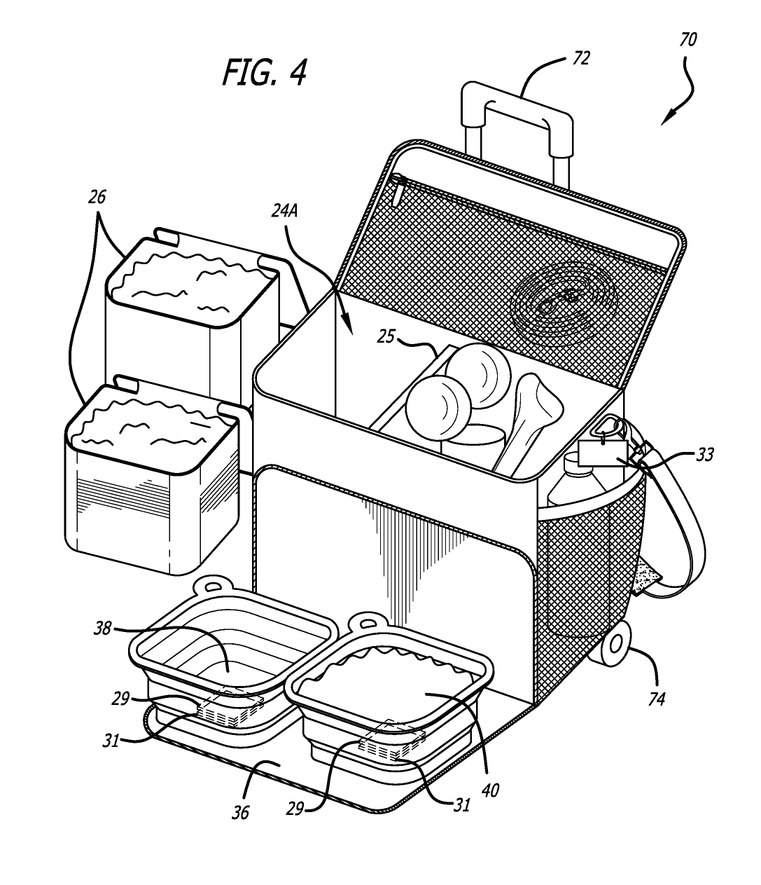

FIG. 4 illustrates yet another preferred embodiment of the present invention. Here, the carrier 70 has the features of the carrier of FIG. 1, but additionally includes an extendable luggage handle 72 that is attached to the back surface and can collapse into a recess or pouch when not in use. Additionally, the a set of wheels 74 along a lower edge that permits the carrier 70 to roll behind a user while being towed by the user. The features of the carrier 70 are otherwise similar to the previous embodiments except for the luggage handle 72 and wheels 74.

While the foregoing descriptions and depictions set forth the inventor's best mode for carrying out the invention, it is to be understood that the invention is not strictly limited to the embodiments described and depicted above. A person of ordinary skill in the art will readily recognize certain modifications and substitutions to the foregoing embodiments, and the present invention is intended to include all such modifications and substitutions. Therefore, unless otherwise expressly noted, the scope of the invention is measured by the appended claims, using their plain and ordinary meanings consistent with the foregoing descriptions and depictions.

I claim:

1. A carrier for pet supplies, comprising:
a flexible walled tote having a lid and a body connected by a zipper, the lid including an inner surface and an outer surface, and a zippered pocket formed on the inner surface;
a padded adjustable shoulder strap attached to the flexible walled tote;
an interior compartment subdivided into first and second sections by a dividing panel;
first and second food storage containers sized to be received in the first and second sections of the interior compartment;
first and second bowls sized to be received in the flexible walled tote;
a fold down tray hinged to an outer lower edge of the flexible walled tote for deployment along a horizontal surface, the fold down tray secured to the outer front surface of the flexible walled tote by a zipper; and
at least one pouch on an outer surface of the flexible walled tote for retaining pet products.

2. The carrier of claim 1, wherein the fold down tray and a lower surface of the first and second bowls include a hook and loop fastener material securing system for retaining the bowls on the tray during use.

3. The carrier of claim 1, further comprising a luggage handle strap on a rear surface for receiving a luggage handle therein.

4. The carrier of claim 3, further comprising a mesh pocket on the rear surface below the luggage handle.

5. The carrier of claim 1, further comprising a pair of wheels along a lower edge.

6. The carrier of claim 5, further comprising an extendable luggage handle mounted to a rear surface.
